(19) United States
(12) Patent Application Publication
(10) Pub. No.: US 2013/0043633 A1
(43) Pub. Date: Feb. 21, 2013

(54) CUTTING BOARD WITH MAGNETS

(71) Applicants: Jordan Michael Schmidt, New York, NY (US); Jared Ryan Schmidt, New York, NY (US)

(72) Inventors: Jordan Michael Schmidt, New York, NY (US); Jared Ryan Schmidt, New York, NY (US)

(21) Appl. No.: 13/211,181

(22) Filed: Aug. 16, 2011

(51) Int. Cl. B23Q 3/00

(52) U.S. Cl. 269/290

(57) ABSTRACT

Embodiments are directed towards a kitchen cutting board that is configured to securely, but removably affix a knife to the cutting board when the knife is not being used. The cutting board may include several cutting surfaces, a shelf that has at least one wall that abuts at least one of the cutting surfaces. A plurality of magnets are disposed within at least one wall and arranged to magnetically affix a ferrous utensil, such as a knife blade, to the wall.

### TECHNICAL FIELD

The present invention relates generally to kitchen cutting boards and, more particularly, but not exclusively, to a cutting board having a plurality of magnets disposed within for holding a cutting utensil when the utensil is not in use.

### BACKGROUND

Cutting boards for use in cutting, chopping, or otherwise preparing food items are well known, today. Many of today's households include one or more different cutting boards. Many boards are constructed from wood, while others are constructed of various other types of materials, including plastics, or the like. Some cutting boards are formed as part of a top to a table, or are built into a kitchen cabinet, while still others are constructed to be portable. However, many of these cutting boards have a common problem. What to do with the cutting utensil when not presently in use? To often, merely setting the utensil on the board may result in the knife being knocked off of the board, or in the case of portable boards, the board being tipped such that the knife slides off of the board. Such situations clearly could result in injury. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is one embodiment illustrating a perspective view of a cutting board having a shelf and a plurality of magnets disposed within a wall of the shelf, the wall being situated lower on the cutting board than a cutting surface;

FIG. 2 is another embodiment illustrating a perspective view of a cutting board having a shelf and a plurality of magnets disposed within a wall of the shelf, the wall being situated higher on the cutting board than a cutting surface;

FIG. 3 is another embodiment illustrating a perspective view of a cutting board having a shelf that divides the cutting board into a plurality of cutting surfaces, the shelf further having a plurality of magnets disposed within two walls of the shelf;

FIG. 4 is another embodiment illustrating a perspective view of a cutting board having a shelf that comprises a cutting surface;

FIG. 5 is another embodiment illustrating a perspective view of a cutting board having a shelf with a plurality of magnets, showing two possible arrangements for the plurality of magnets;

FIG. 6 is an embodiment illustrating a perspective view of a cutting board usable without a shelf; and

FIG. 7 is another embodiment illustrating a perspective view of a cutting board having a removable and/or slidable shelf.

### DETAILED DESCRIPTION

Embodiments now will be described more fully hereinafter with reference to the accompanying drawings, which form a part hereof, and which show, by way of illustration, specific embodiments which may be practiced. This invention may, however, be embodied in many different forms and should not be construed as limited to the embodiments set forth herein; rather, these embodiments are provided so that this disclosure will be thorough and complete, and will fully convey the scope to those skilled in the art. The following detailed description is, therefore, not to be taken in a limiting sense.

Throughout the specification and claims, the following terms take the meanings explicitly associated herein, unless the context clearly dictates otherwise. References to “one embodiment,” “an embodiment,” “another embodiment,” as used herein indicates that a particular feature, structure, or characteristic described in connection with the embodiment is included in at least one embodiment. However, the phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “utensil” refers to any form of cutlery item or article having ferrous or ferromagnetic properties such that the item or article is magnetically attracted to a magnet, as described further below. As such, utensils include any of a variety of knives, and other items useable for chopping and/or cutting various objects.

As used herein, the term “substantial” refers to being within some tolerance of being exact. For example, as used herein, substantially flush refers to two or more surfaces being at a same level as each other within some tolerance. Typically, the tolerance is based on manufacturing tolerances. Similarly, substantially perpendicular refers to two surfaces being within some tolerance of being directed ninety degrees from each other.

The following briefly describes the various embodiments in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards a kitchen cutting board that is configured to securely, but removably affix a knife to the cutting board when the knife is not being used. One embodiment of the cutting board may include at least one cutting surface and a shelf that has at least one wall that abuts at least one of the cutting surfaces, such that the wall and at least one of the cutting surfaces share a common edge. A plurality of magnets are disposed within at least one wall and arranged to magnetically affix a ferrous utensil, such as a knife blade, to the wall. In this manner, the utensil is removably secured to the board, minimizing likelihood of the utensil falling from the board.

Various arrangements of the shelf and magnets are described in more detail below, including having the magnets extend through the cutting board so that when a ferrous utensil is placed onto the cutting surface, the utensil may be attracted to the magnets and become removably affixed to the cutting surface. In this manner, should a chef select to rest the utensil on the board, tipping the board is unlikely to result in the utensil sliding off of the board.

In some embodiments, an end of each magnet may extend perpendicular outward from a surface of the wall, such that when a ferrous utensil is affixed to the magnets, there is a space between the utensil and the wall to allow air to circulate.

In one embodiment, the cutting board may be configured as separable portions, including a lower base board portion and an upper board portion. In one embodiment, at least one of the lower base board portion and the upper board portion may include a cutting surface. The upper board portion includes a first end and a second end that forms two walls or sides to the upper cutting board portion. In one embodiment, the walls are located at opposing ends of the upper cutting board portion. Moreover, a plurality of magnets are disposed within at least one wall of the upper board portion and arranged to magnetically affix a ferrous utensil.

In one embodiment, the separable portions of the cutting board may be configured such that the upper board portion may be slid across the lower base board portion or otherwise affixed to the lower base board portion. This may be achieved using any of a variety of mechanism, including a groove/tongue arrangement or the like.

In still another embodiment, the cutting board may be configured as a single board, at least one side having a cutting surface. At least one end of the cutting board may operate as a wall having a plurality of magnets disposed within the at least one wall and arranged to magnetically affix a ferrous utensil.

It should also be recognized that while several illustrations show various ferrous utensils, these are shown for illustration of possible usage of the cutting boards, and not necessarily as components of the variously claimed embodiments.

### PARTIAL LIST OF REFERENCE NUMERALS

10 cutting surface length
11 board width
12 shelf length
13 wall height
14 shelf height
100 cutting board
102 cutting surface
103 plurality of magnets, and illustrating at least one end of each magnet being flush with a surface of a wall
104 wall abutting the cutting surface
106 shelf
108 non-limiting, non-exhaustive example of a ferrous utensil
301-302 a plurality of cutting surfaces
303 plurality of magnets
304-305 a first wall and a second wall
306 a shelf
310-311 non-exhaustive examples of utensils
401-402 a plurality of cutting surfaces, wherein at least one cutting surface is a shelf
404 wall
403 plurality of magnets
405 non-exhaustive example of utensil
501-502 plurality of cutting surfaces, at least one cutting surface is a shelf
504 wall
505 one embodiment of a plurality of magnets extending through the cutting board, and under at least one cutting surface
506 one embodiment of a plurality of magnets having at least one end extending perpendicular outward from a surface of a wall
602 cutting surface
603 plurality of magnets, and illustrating at least one end of each magnet being flush with a surface of a wall
604 end/wall (or side) abutting the cutting surface
605-606 non-limiting, non-exhaustive examples of ferrous utensils
607 wall or side abutting the cutting surface
701 cutting surface for a separable base board portion
702 cutting surface for a separable upper board portion
703 plurality of magnets, and illustrating at least one end of each magnet being flush with a surface of a wall
704 end/wall (or side) abutting the cutting surface
705 non-limiting, non-exhaustive example of a ferrous utensil
706-707 groove arrangement
708-709 tongue arrangement

### ILLUSTRATIVE DESCRIPTIONS OF EMBODIMENTS

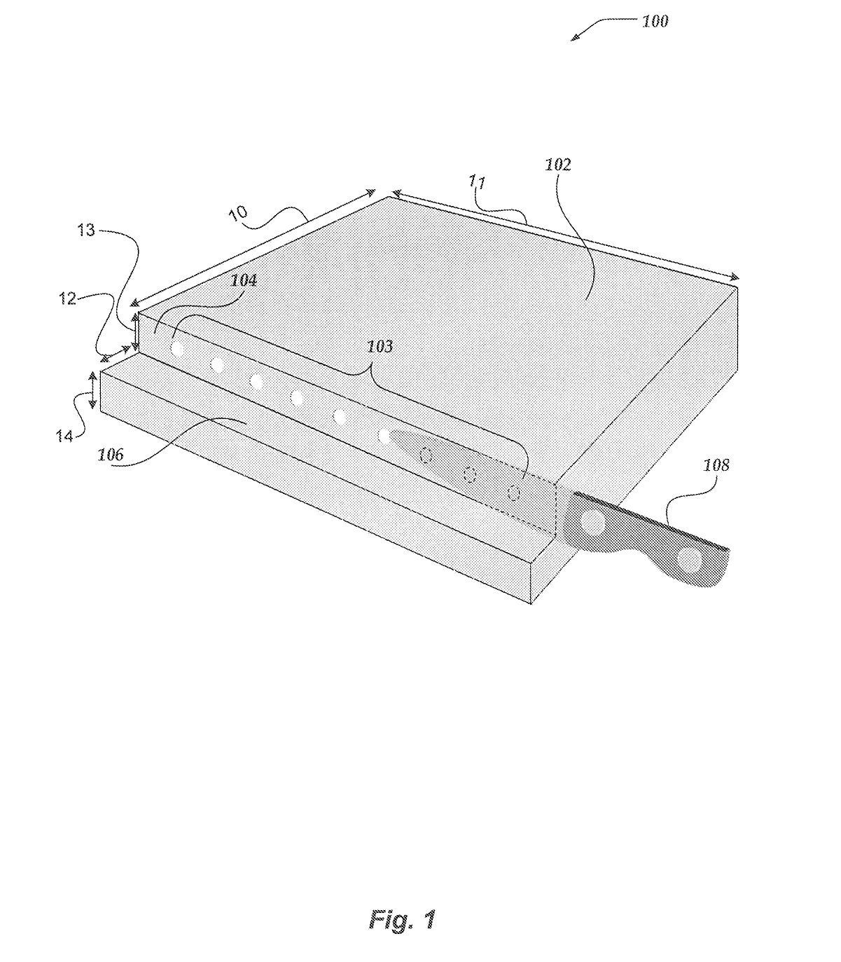

FIG. 1 is one embodiment illustrating a perspective view of a cutting board 100. Not all the components may be required to practice various embodiments, and variations in the arrangement and type of the components may be made. However, as illustrated, cutting board 100 includes cutting surface 102 and a shelf 106. The shelf 106 includes a wall 104 that abuts the cutting surface 104. Also shown are a plurality of magnets 103 that are disposed within wall 104. As illustrated, one end of each of the plurality of magnets is flush with a surface of the wall 104.

Additionally, shown is a non-exhaustive, non-limiting example of a utensil 108 being magnetically affixed to wall 104 due to the magnetic attractive force of the plurality of magnets 103. It should be noted that the placement of example utensil 108 is also not to be construed as limiting. For example, while a handle of utensil 108 is illustrated as extending outward beyond cutting block 100, other locations are also possible. For example, the handle of utensil 108 might also be composed of ferromagnetic material, and thus, could also be affixed to cutting board 100, when appropriately placed.

Cutting board 100 may be constructed of any of a variety of materials, including wood, plastic, or even a combination of wood and plastic. For example, cutting board 100 may be constructed of polyethylene or polypropylene, or the like. Other materials may also be employed. In some embodiments, cutting surface 102, wall 104, and shelf 106 may be constructed from a single unity component. That is, in some embodiments, a single block of wood, plastic, or other material, may be cut, or otherwise shaped, to create the shelf 106 with wall 104. For example, a section of the single block of material may be cut from the block of material to form the shelf 106 having a wall 104. However, in other embodiments, such as with plastics, a mold might be formed into which the plastic might be poured into to create the desired structure. Still other approaches may be used to manufacture cutting board 100. For example, wood fibers may be compressed into the structure of cutting board 100 having shelf 106, wall 104, and cutting surface 102. Thus, cutting board 100 is not to be construed as being limited to a particular manufacturing process.

Cutting board 100 may be manufactured having various cutting surface lengths 10 and/or various board widths 11. Thus, cutting board 100 is not to be construed as being limited to a particular width 11 or cutting surface length 10. The shelf height 14 may be selected to provide an overall desired thickness of cutting board 100. Further, various shelf lengths 12 and wall height 13 may also be selected. In some embodiments, the wall height 13 might be selected based on a width of a blade of a utensil that is to be affixed to cutting board 100. For example, wall height 13 might be selected to ensure that a selected blade does not extend above the wall height 13. By selecting a wall height 13 according to a desired blade width, additional protection may be provided, by minimizing likelihood that the blade is bumped when the utensil is affixed to wall 104. However, the wall height 13 may be selected based on any of a variety of other criteria. For example, for some knives, or other utensils, the wall height 13 might be selected to ensure a desired amount of a surface of a defined blade is flush against wall 104, independent of whether some of the blade extends above wall 104. Because it is recognized that various blade widths are available, the wall height 13 may be selected to accommodate a pre-selected blade width, an average blade width, or other criteria. For example, wall height 13 could even be selected to balance an esthetical appearance of cutting board 100 while providing a desired surface area on wall 104 for holding the utensil.

A plurality of magnets 103 is illustrated as being disposed within wall 104 and across a surface of wall 104. The number of magnets may vary based on a variety of factors, including, but not limited to a size of the magnets selected, a distance between the magnets desired, a magnetic strength of the magnets, and the wall height 13. In one embodiment, the plurality of magnets 103 may be selected to provide a magnetic attractive force that is determined to be sufficient to attract a ferrous utensil such that the utensil can be securely, but removably affixed to cutting board 100.

In one embodiment, the plurality of magnets 103 may be shaped as disk shaped plugs that are configured to be permanently attached into wall 104. For example, the magnets might be pressed into holes that are bored into wall 104 and/or glued into the holes. As illustrated in FIG. 1, an end of each of the plurality of magnets 103 is illustrated as being flush with a surface of wall 104. However, as discussed further below, other configurations are also envisaged.

While a shape of the magnets is shown in FIG. 1 as being circular in shape, other shapes may also be employed. For example, at least an end of each of the plurality of magnets 103 may be oval, heart shaped, triangular shaped, rectangular shaped, star shaped, or any of a variety of other shapes. Further, a color of the magnets may also vary, and thus, embodiments are not to be construed as having a particular shape or color for the plurality of magnets 103.

Moreover, although the plurality of magnets 103 are illustrated as forming a single row of magnets across a face of wall 104, other embodiments may include a plurality of rows, or even an uneven distribution of magnets. Thus, the arrangement of the plurality of magnets 103 is not to be construed as limiting.

Further, while FIG. 1 illustrates a plurality of distinct magnets as being employed, other embodiments are not so constrained. For example, one or more elongated strips of magnetic material might be affixed to or within wall 104. For example, a single strip of magnetic material might be inserted into wall 104 and extend for substantially a width of cutting board 100, or to within some distance from a side edge of wall 104. In another embodiment, multiple magnetic strips might be inserted into wall 104, each of the strips being located near to a side edge of wall 104, while little or no magnetic material is located towards a center location along wall 104. Other arrangements of the plurality of magnets 103 are also envisaged.

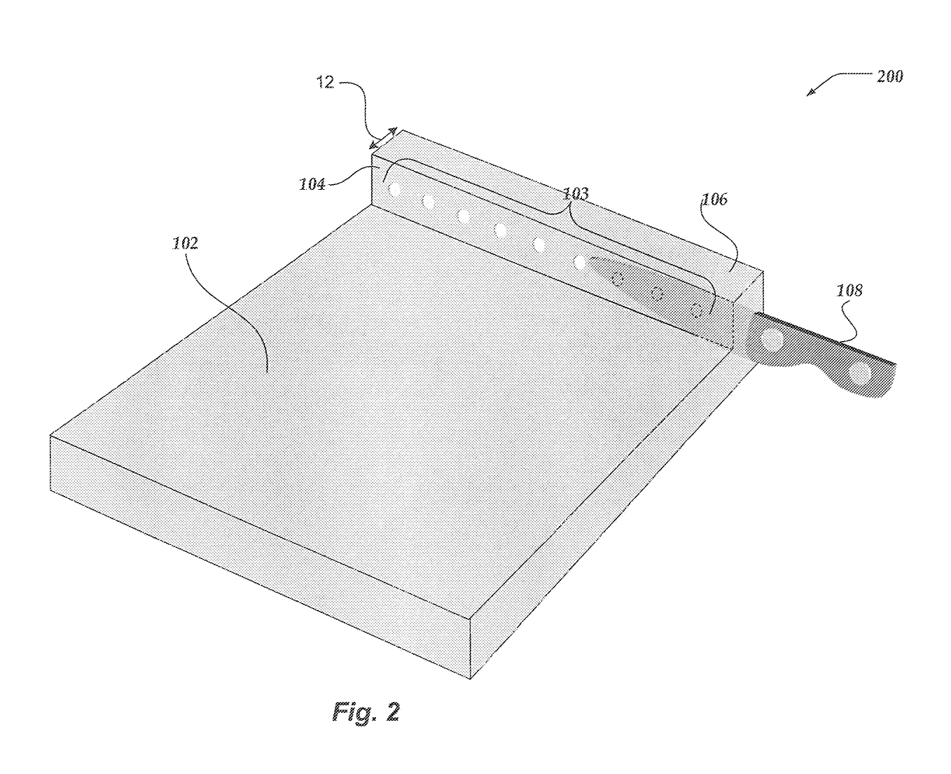

As illustrated in FIG. 1, the location of shelf 106 is shown to be lower than the cutting surface 102 on cutting board 100. However, other embodiments are not so limited. Thus, FIG. 2 provides another embodiment illustrating a perspective view of a cutting board 200 having a shelf 106 and a plurality of magnets 103 disposed within a wall 104 of the shelf 196, the wall 104 and shelf 106 being situated higher on the cutting board 200 than the cutting surface 102. In this embodiment, the shelf length 12 may be selected so as to provide a sufficient ‘back’ support to wall 104 when a utensil 108 is affixed. Thus, it is readily apparent that the shelf 106 and the cutting surface 102 need not be in a same geometric plane—or on a same level—as each other, although they could be on a same plane. As with cutting board 100 of FIG. 1, the arrangements of the plurality of magnets 103 may vary, as discussed above.

Cutting board 200 may also be constructed from a single unity component, or from multiple components that may then be glued or otherwise permanently attached to each other. For example, shelf 106 with its respective wall 104 might be separately constructed and then glued, or otherwise attached, to cutting surface 102. As shown in FIG. 2, shelf 106 is located at one end or edge of cutting surface 102. However, other configurations are also envisaged.

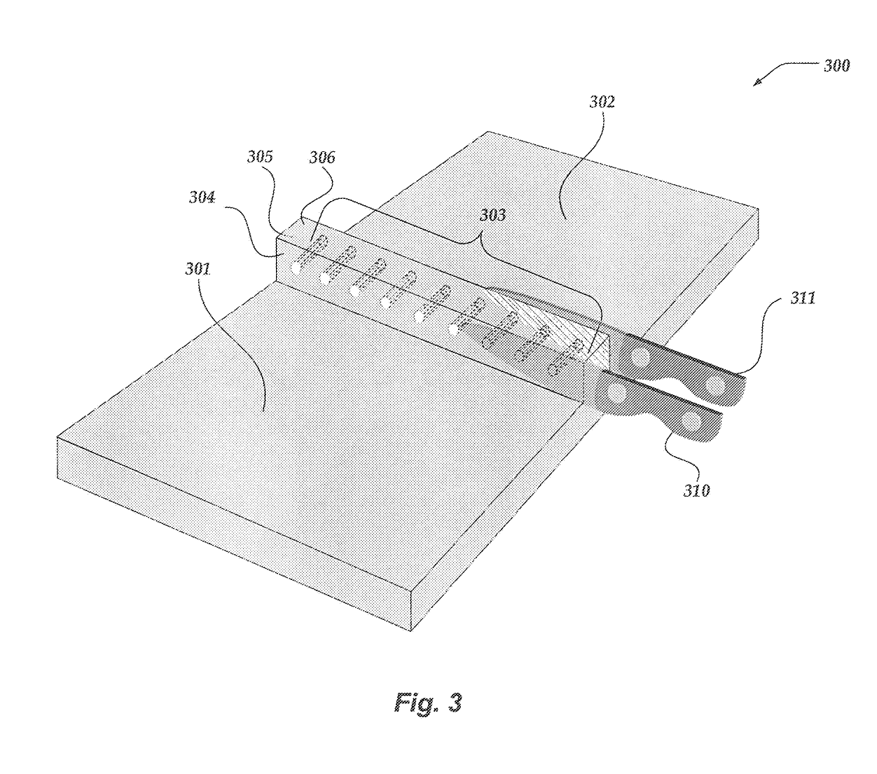

For example, FIG. 3 shows another embodiment of a cutting board 300 illustrating a perspective view of a cutting board having a shelf 306 that divides the cutting board 300 into a plurality of cutting surfaces 301-302, and the shelf 306 further having a plurality of magnets 303 disposed within two walls 304-305 of the shelf 306. While shelf 306 is illustrated as dividing the cutting board 300 into two cutting surfaces of approximately equal lengths, in other embodiments, the lengths of the two cutting surfaces may be different.

Non-limiting, non-exhaustive example utensils 310-311 are illustrated as being magnetically affixed to the plurality of magnets 303 such that the utensils are securely, but removably attached to the respective walls 304-305.

As shown in FIG. 3, the plurality of magnets 303 are configured such that one end of each of the magnets is flush with a surface of a first wall 304, and a body of each of the magnets extends through shelf 306 such that a second end of each magnet is flush with a surface of a second wall 305. However, other arrangements of the plurality of magnets 303 are also envisaged. For example, in another embodiment, the magnets need not extend through shelf 306, such that each end of each magnet is flush with a surface of one of the walls 304-305. For example, in one embodiment, a first plurality of magnets is disposed within wall 304 and has one end of each magnet flush with a surface of wall 304, while a second plurality of magnets is disposed within wall 305 and has one end of each of the second plurality of magnets flush with a surface of a second wall 305.

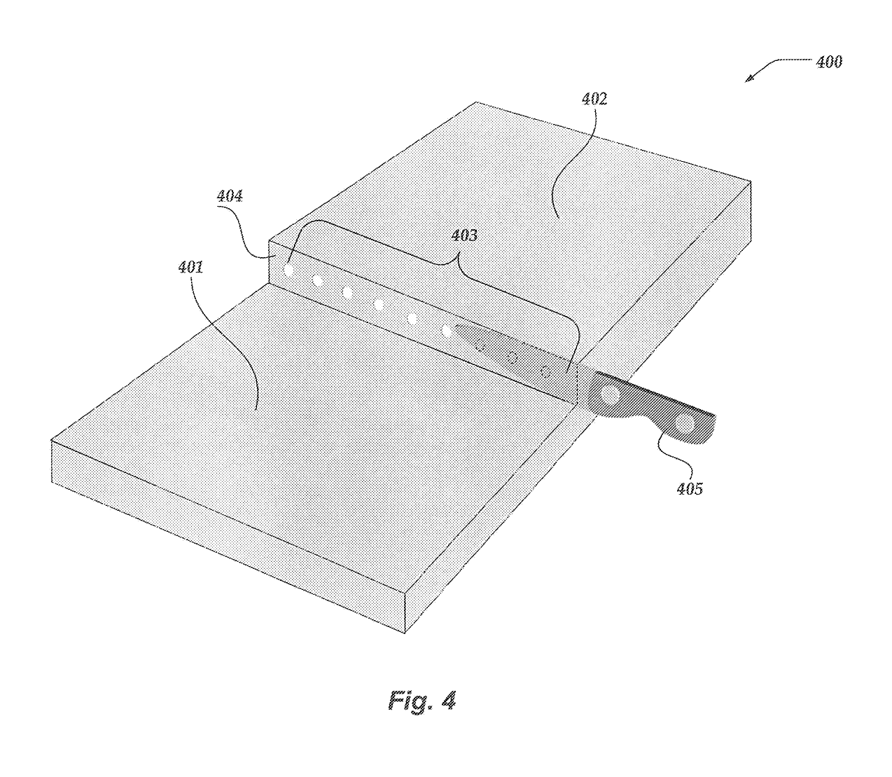

FIG. 4 is another embodiment illustrating a perspective view of a cutting board 400 having a shelf 401 that also comprises a cutting surface. Thus, in this embodiment, two cutting surfaces 401-402 are provided. Wall 404 is shown having a plurality of magnets 403 disposed within wall 404, and having one end of each of the magnets 403 being flush with a surface of wall 404. As illustrated, cutting surface 401 may then be comprised of shelf 401. While a length of each of the cutting surfaces 401-402 may be approximately the same, in other embodiments, a length of one of the cutting surfaces 401 or 402 may be different from a length of the other cutting surface 402 or 401.

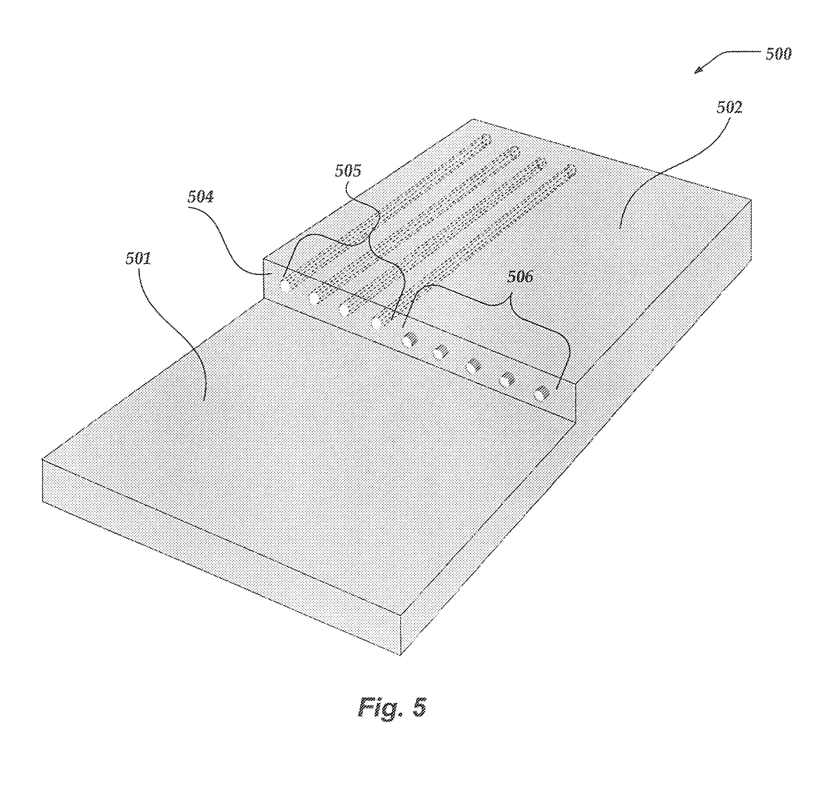

FIG. 5 is another embodiment illustrating a perspective view of a cutting board 500 having a shelf 501 with a plurality of magnets 505-506 disposed with a wall 504. Cutting board 500 further illustrates two possible arrangements for the plurality of magnets (plurality of magnets 505 and plurality of magnets 506). It should be noted that the two arrangements need not be within a same embodiment, but may be within two separate embodiments. Thus, plurality of magnets 505 might be within a different cutting board than plurality of magnets 506, although they need not be.

As shown in FIG. 5, plurality of magnets 505 are illustrated as having an extended body that ‘runs’ substantially through a selected length of cutting board 500 and under cutting surface 502. In this manner, when a utensil is placed upon the cutting surface 502 of cutting board 500, the plurality of magnets 505 might magnetically affix the utensil to the cutting surface 502. The selection of a magnetic strength of the magnets are made such that when the utensil is in use, such as cutting an object, the utensil is unlikely to be forced into an unusable position on the cutting board. For example, it is typically undesirable for the utensil to be forced into a reclining position on the cutting board, such that the utensil cannot be easily employed, for cutting, chopping, or otherwise used. However, the magnetic strength of the plurality of magnets may be selected to ensure that when the utensil is placed sideways onto the cutting surface having the magnets underneath, the utensil is held removably secure thereon. In one embodiment, selection of the magnets might be such that a force of between about three to about 20 pounds might be required to be applied to free the utensil. However, other values may also be selected. Similarly, such forces might also be useable for when the utensil is affixed to a wall of the cutting board having the plurality of magnets disposed therein.

Also shown in FIG. 5 is a plurality of magnets 506 where an end of each of the magnets extends perpendicularly outward from wall 504 at a length that allows air to circulate between wall 504 and an affixed ferrous utensil. The length that extends outward may range from as little as a couple of millimeters to upwards of about 20 millimeters, although other lengths may also be selected. Thus, the embodiments are not to be construed as being constrained to a particular length.

It should be noted that while the arrangements of the plurality of magnets illustrated in FIGS. 1-4 do not show ends extending beyond a wall, or a body of a magnet extending through a length of a cutting surface, such as illustrated in FIG. 5, these embodiments may also include one or more of these configurations, as well.

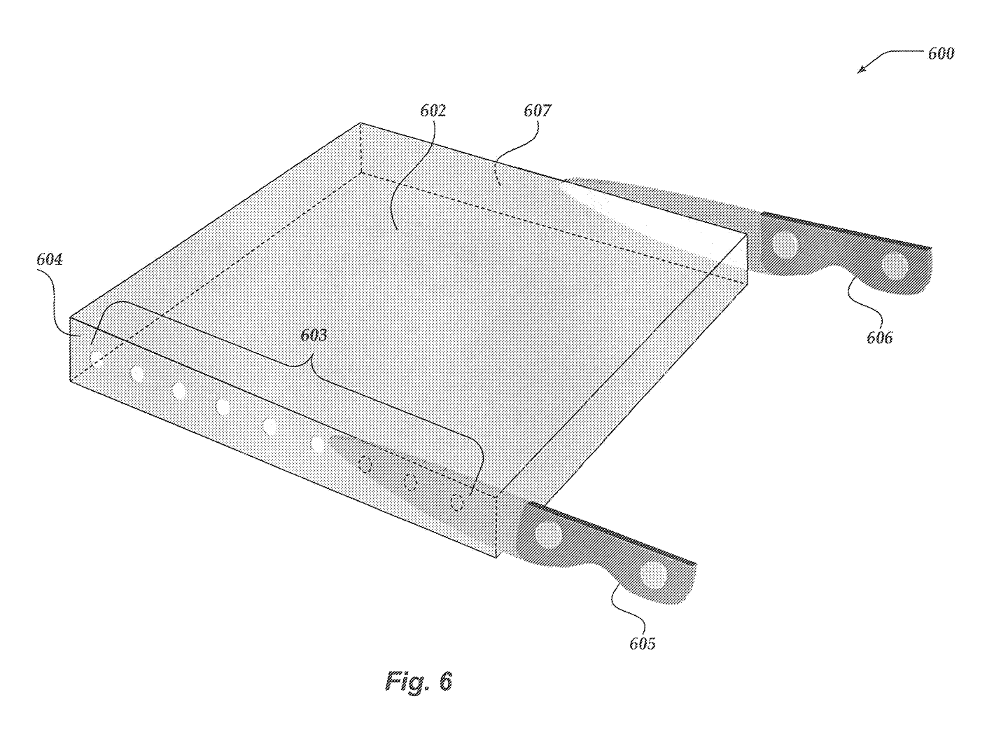

FIG. 6 is another embodiment illustrating a perspective view of a cutting board 600. In this embodiment, cutting board 600 includes at least one cutting surface 602. Cutting board 600 further includes a first end and a second end, also herein called walls, where each end/wall abuts the at least one cutting surface 602. At least one wall (604 and/or 607) (or end) includes a plurality of magnets 603 disposed within at least one of the ends/walls, and having one end of each of the magnets 603 being flush with a surface of the end/wall (604 and/or 607). As noted above, cutting board 600 may also include any of the other various arrangements of the plurality of magnets 603 disclosed above, including for example, magnets that extend outward from the surface of the end/wall, magnets that extend through a length of cutting board 600, or the like. As shown for illustration purposes are also two ferrous utensils 605-606.

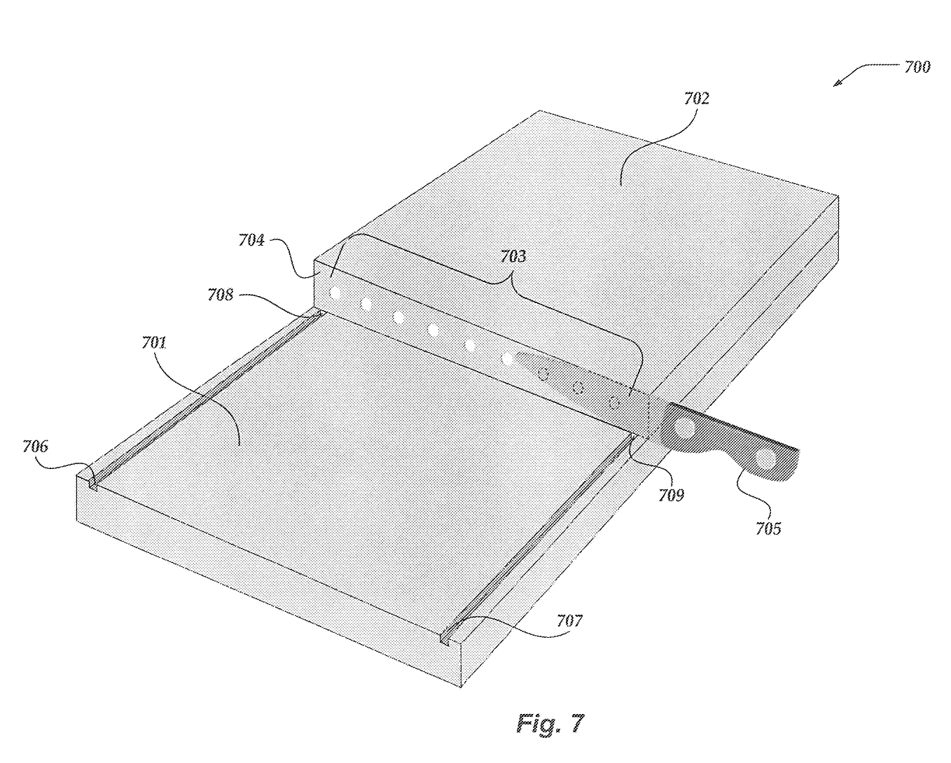

FIG. 7 is another embodiment illustrating a perspective view of a cutting board 700. In one embodiment, cutting board 700 is configured as separable portions, including a lower base board portion 701, and an upper board portion 702. In one embodiment, both portions of cutting board 700 include at least one cutting surface. In one embodiment, the two portions may be separated from each other and used by themselves. In any event, as illustrated, at least upper board portion 702 may include a wall 704 that has a plurality of magnets 703 disposed within it and arranged to magnetically affix a ferrous utensil. It should be readily recognized however, that lower base board portion 701 may also include at least one wall also having a plurality of magnets disposed within it. As noted elsewhere, various arrangements of the plurality of magnets may be employed in cutting board 700. Ferrous utensil 705 shows one possible location for affixing to at least one of the plurality of magnets 703.

Also shown is one non-limiting example of a mechanism usable to separably attach the upper board portion 702 to lower base board portion 701. Shown in the figure is a groove (706-707) and tongue (708-709) arrangement, where the tongues may be slid into and along the grooves to allow upper board portion 702 to be slid along the cutting surface of lower base board portion 701. In one embodiment, the grooves (706-707) may run a length of one or both sides of the lower base board portion 701's cutting surface. However, less than an entire length is also envisaged. Similarly, the tongues (708-709) may be affixed or be constructed as part of an underside portion of the upper board portion 702, and run the length of the underside or less than the length of the underside of the upper board portion 702. Other mechanisms are also envisaged, including a lip arrangement on edges of the lower base board portion 701, or the like.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A cutting board, comprising:
a cutting surface upon which to cut objects;
a shelf having at least one wall abutting the cutting surface; and
a plurality of magnets disposed within the at least one wall and arranged to magnetically affix a ferrous utensil to the wall.

2. The cutting board of claim 1, wherein the shelf is situated lower than the cutting surface on the cutting board.

3. The cutting board of claim 1, wherein the shelf is situated above the cutting surface on the cutting board.

4. The cutting board of claim 1, wherein the shelf is situated above the cutting surface on the cutting board and divides the cutting surface into a first cutting surface and a second cutting surface.

5. The cutting board of claim 4, wherein the shelf further comprises a second wall abutting the second cutting surface.

6. The cutting board of claim 5, wherein the plurality of magnets are disposed within the wall and the second wall, and are arranged to magnetically affix a ferrous utensil to either the wall or the second wall.

7. The cutting board of claim 1, wherein the plurality of magnets extend through the cutting board, under the cutting surface to further allow a ferrous utensil to be magnetically affixed to the cutting surface.

8. The cutting board of claim 1, wherein the plurality of magnets extend perpendicularly outward from the wall.

9. The cutting board of claim 1, wherein an end of each of the plurality of magnets is substantially flush with a surface of the wall and is visible on the wall.

10. The cutting board of claim 1, wherein the shelf further comprises a second cutting surface.

11. A board, comprising:
a plurality of cutting surfaces, each of the plurality of cutting surfaces concurrently accessible for cutting objects;
a shelf having at least one wall abutting at least one of the cutting surfaces; and
a plurality of magnets disposed within the at least one wall and arranged to magnetically affix a ferrous utensil to the wall.

12. The board of claim 11, wherein at least one cutting surface is on a same plane with respect to another cutting surface.

13. The board of claim 11, wherein at least one cutting surface is on a different plane with respect to another cutting surface.

14. The board of claim 11, wherein the shelf is situated above the plurality of cutting surfaces and divides the board into the plurality of cutting surfaces.

15. The board of claim 11, wherein an other plurality of magnets are disposed within a second wall of the shelf and are arranged to magnetically affix an other ferrous utensil to the second wall.

16. The board of claim 11, wherein ends of each of the plurality of magnets extend perpendicularly outward from the at least one wall at a length that allows air to circulate between the at least one wall and the affixed ferrous utensil.

17. The board of claim 11, wherein at least some of the plurality of magnets extend substantially through the board and are arranged to magnetically affix the ferrous utensil to at least one cutting surface.

18. The board of claim 11, wherein the shelf is at least one of the plurality of cutting surfaces.

19. The board of claim 11, wherein the shelf has a length that is less than a length of at least one of the cutting surfaces.

20. The board of claim 11, wherein the shelf is configured to enable a cutting edge of a knife to rest on the shelf, when the knife is magnetically affixed to the at least one wall.

21. A cutting board, comprising:
a cutting surface upon which to cut objects;
a first end and a second end of the cutting board, each end abutting the cutting surface and forming sides to the cutting board; and
a plurality of magnets disposed within at least one of the ends and arranged to magnetically affix a ferrous utensil to the end.
